(19) United States
(12) Patent Application Publication
(10) Pub. No.: US 2015/0318821 A1
(43) Pub. Date: Nov. 5, 2015

(54) CONCENTRATOR PHOTOVOLTAIC ASSEMBLY

(71) Applicant: UNIVERSITY OF OTTAWA, Ottawa (CA)

(72) Inventor: Richard BEAL, Ottawa (CA)

(21) Appl. No.: 14/654,129

(22) PCT Filed: Dec. 20, 2013
(86) PCT No.: PCT/CA2013/051004

§ 371 Date: Jun. 19, 2015

Related U.S. Application Data
(60) Provisional application No. 61/740,536, filed on Dec. 21, 2012.

(51) Int. Cl. H02S 40/22

(52) U.S. Cl. CPC H02S 40/22

(57) ABSTRACT

A concentrator photovoltaic module that has a secondary optical element that has alignment features that cooperate with alignment feature of a solar cell assembly to self-align the secondary optical element with the solar cell. The secondary optical element is secured directly to the backplate or to the solar cell assembly. The secondary optical element is spaced-apart from the solar cell, which avoids shear stress between the secondary optical element and the solar cell.

### FIELD

The present disclosure relates generally to solar cell assemblies. More particularly, the present disclosure relates to solar cell assemblies for concentrator photovoltaic (CPV) applications.

### BACKGROUND

CPV technology uses optics such as lenses and mirrors to concentrate a large amount of solar radiation or sunlight onto a small area of solar photovoltaic cells to generate electricity. More specifically, CPV systems utilize an optical train, or an optical system, to concentrate sunlight onto small, highly efficient multi-junction solar cells.

Such optical trains typically include a refractive Fresnel lens primary optical element (POE) optically coupled over free space to a secondary optical element (SOE), which guides concentrated light onto a solar cell. Examples of optical trains can include: (1) A Fresnel lens primary and refractive secondary; (2) A Fresnel lens primary and a reflective secondary; (3) A Fresnel lens primary without a secondary; (4) A plano-convex lens primary without a secondary; (5) A plano-convex lens primary and a refractive secondary; (6) A plano-convex lens primary and a reflective secondary; (7) A reflective primary, secondary, and, optionally, tertiary optics; and (8) a light-guiding primary with or without a refractive secondary.

The POE harvests light over a relatively large area and facilitates the initial focusing of light, while the SOE provides secondary concentration of the light focused by the POE, improves the spatial uniformity of light incident on the solar cell, and enhances the angle of acceptance of sunlight by solar panel. Typically, the SOE is adhesively bonded to the solar cell. However, other approaches to optically couple a SOE to a solar cell are known. For example, one such approach includes an integrated circuit package that seals, or partially seals, a solar cell behind a window and an optical element that is coupled to the window to illuminate the solar cell. In another example, the SOE is bonded to the solar cell carrier assembly, which typically includes the solar cell, a top electrical contact, a bottom electrical contact, a bypass diode, and electrical wire connectors. The solar cell carrier assembly is typically mounted (secured) to a backplate.

Prior art optical train designs have disadvantages. Examples of these disadvantages include: (1) Bonding of the SOE directly to the solar cell surface can create shear stress on the solar cell and reduces reliability; (2) Bonding the SOE to the solar cell carrier assembly requires a large solar cell carrier assembly and is therefore costly; (3) Bonding of the SOE to the solar cell or to the solar cell carrier assembly creates a hot connection area that can thermally induce stress; (4) Bonding the SOE to the solar cell requires precise alignment and therefore more expensive manufacturing processes; and (5) The adhesive used to bond the SOE to the solar cell must provide both adhesive and light coupling properties, which can compromise the efficacy of both.

In light of the above, improvements in optical systems used in CPV applications are desirable.

### SUMMARY

It is an object of the present disclosure to obviate or mitigate at least one disadvantage of previous CPV systems.

In a first aspect, there is provided a concentrator photovoltaic(CPV) module that comprises: a backplate; a solar cell assembly (SCA) secured to the backplate, the SCA having a solar cell mounted thereon, the SCA defining an SCA alignment feature; and an optical element to guide light onto the solar cell, the optical element having an optical element alignment feature, the SCA alignment feature to cooperate with the optical element alignment feature to align the optical element with respect to the solar cell.

In another aspect, there is provided an optical element to guide light onto a solar cell mounted on a solar cell assembly (SCA), the SCA being mounted on a backplate. The optical element comprises: an optical element alignment part to cooperate with an SCA alignment part to align the optical element to the solar cell when the optical element is mated to the SCA; and an underside portion for bonding to one of the SCA and the backplate.

In some embodiments, the SOE described herein can be affixed to the backplate. The backplate supports the cell carrier, as the cell carrier is mounted onto the backplate. This has at least two (2) benefits: (1) It allows the carrier to be much smaller and to reduce the costs associated with producing a carrier large enough to support both at least the cell and the SOE; and (2) It allows for stress on the cell to be minimized.

Indeed, in some embodiments, since the backplate is cooler than the carrier, and that the adhesive bondline between the SOE and the backplate is cooler, stress due to thermal mismatch and thermal cycling on the optical train is reduced, and the durability, lifetime, and reliability of the CPV system is enhanced.

Additionally, mounting both the SCA and the SOE on the backplate ensures the mounting surfaces for both components are aligned (as it is the same surface), thereby removing a source of angular misalignment. It also reduces the torque on the bond between the carrier and the backplate and protects the bypass diode from off-axis light; further, it simplifies optical train assembly, enhances reliability and reduces the cost of the assembly.

Embodiments of the SOE described herein significantly reduce the sophistication, and therefore cost, of the machinery required to align the cell and optic because the rotational and translational alignment is physically built in to the SOE underside. With the new SOE design, it is conceivable that the SOE could be accurately aligned by hand. By eliminating the need to bond the SOE to the SCA surface, the surface area, and therefor cost, of the SCA can be greatly reduced.

As such, when incorporated into a cell system, the new optical train will enable the widespread deployment of CPV systems by reducing materials and assembly costs.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 shows a side view of an embodiment of a secondary optical element of the present disclosure.

FIG. 2 shows the same view of the secondary optical element of FIG. 1.

FIG. 3A shows a centre, cross-sectional view of the secondary optical element of FIG. 2.

FIG. 3B shows a bottom view of the secondary optical element of FIG. 2.

FIG. 4 shows an embodiment of a solar cell assembly in accordance with the present disclosure.

FIG. 5 shows a side view of the solar cell assembly of FIG. 4.

FIG. 6 shows another side view of the solar cell assembly of FIG. 4.

FIG. 7 shows a top view of the solar cell assembly of FIG. 4.

FIG. 8 shows a side view of a secondary optical element optically and physically coupled to a solar cell assembly.

FIG. 9 shows a side view of a secondary optical element optically and physically coupled to a solar cell assembly, with the secondary optical element secured (bonded) to a backplate.

FIG. 10 shows a gap between a secondary optical element and a backplate, with the secondary optical element mounted on a solar cell assembly.

FIG. 11 shows a side view of an embodiment of a secondary optical element of the present disclosure.

FIG. 12 shows the secondary optical element of FIG. 11 optically and physically coupled to a solar cell assembly.

FIG. 13 shows a perspective view of the secondary optical element and solar cell assembly of FIG. 12.

FIG. 14 shows the secondary optical element of FIG. 3A positioned (self-aligned) with the solar cell of the solar cell assembly of FIG. 4.

FIG. 15 shows a side cross-sectional view of an embodiment of a secondary optical element of the present disclosure bonded directly to a backplate.

FIG. 16 shows an example of a secondary optical element being self-aligned with a solar cell assembly and being bonded, with an adhesive to the solar cell assembly.

FIG. 17 shows a side, cross-sectional view of an embodiment of a CPV module of the present disclosure.

### DETAILED DESCRIPTION

The present disclosure relates to CPV modules that comprise a solar cell assembly secured to a backplate and a secondary optical element that is bonded to the backplate or to the solar cell assembly. The secondary optical element is optically aligned with a solar cell of the solar cell assembly. Advantageously, the solar cell is spaced-apart from the secondary optical element, which effectively removes any shear stress between the secondary optical element and the solar cell. This improves reliability.

Further, the bond that maintains the alignment between the solar cell and the secondary optical element is between the secondary optical element and the backplate or the solar cell assembly, not between the secondary optical element and the solar cell. As such, the bond that maintains the alignment between the solar cell and the secondary optical element is not subject to direct sunlight illumination, which means that heat generated at the solar cell upon being illuminated does not give rise to significant heat-induced strain between the solar cell and the secondary optical element that may cause the alignment to vary over time. Further, the secondary optical element and the solar cell assembly have complementary alignment features (alignment parts) that allow for self-alignment of the secondary optical element with the solar cell, which significantly reduces the time required to align the secondary optical element with the solar cell of the solar cell assembly. Furthermore, the present disclosure allows for a reduced-size solar cell assembly, which provides cost savings.

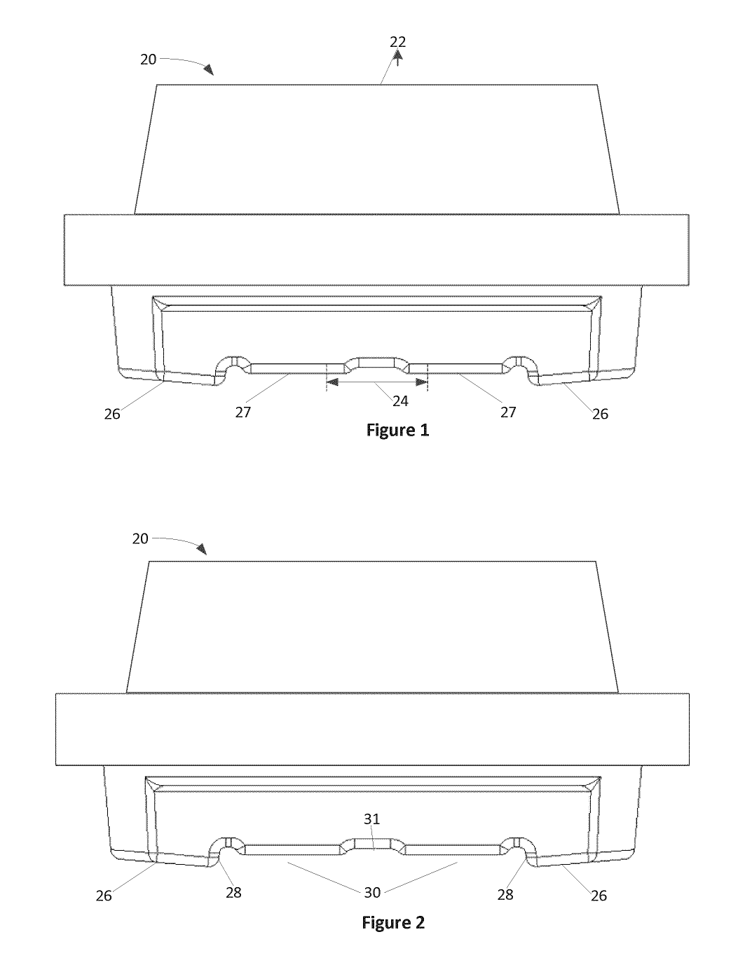

FIG. 1 shows a side view of an embodiment of a secondary optical element (SOE) 20 of the present disclosure. The SOE 20 has a light input surface 22 that receives light from a primary optical element (not shown). The primary optical element (not shown) and the SOE 20 can define a non-imaging optical system or an imaging optical system. The light input surface 22 is shown as flat; however, this need not be the case. Any suitably-shaped light input surface that allows concentrating light onto the surface of a solar cell is to be considered within the scope of present disclosure. Further, the light input surface can be segmented into any suitable number of segments. The SOE 20 concentrates the light to an area 24, where it is received by a solar cell (not shown). The area can have any suitable geometry such as, for example, a square, a rectangle, or a circle.

The SOE 20 has underside surfaces 26, which can also be referred to as non-optical surfaces or areas. In the context of the present disclosure, a non-optical surface is a surface that is not used to transmit light. As will be described further below, the SOE 20 can be bonded to a backplate by placing any suitable bonding agent between the underside surfaces 26, or a portion thereof, and the backplate. The underside surfaces 26 are inwardly slanted; however, this need not be the case. For example, in some embodiment, the underside surfaces 26 can be level, i.e., parallel the level surfaces 27 that, as will be described further below, serve to rest the SOE 20 onto a solar cell assembly. As will be discussed further below, when securing the SOE 20 overs a solar cell assembly and to a backplate, a bonding agent (e.g., a glue) is placed on the backplate and the SOE 20 is placed with the undersides 26 on the bonding agent. The slant in the underside surfaces 26 allows the bonding agent to be pushed away from the solar cell assembly as the SOE is moved toward the backplate.

FIG. 2 shows the same view of the SOE 20 as in FIG. 1. In FIG. 2, the SOE 20 is shown as having inboard surfaces 28, with each inboard surface being opposite the other. The SOE defines a recess 30 between the inboard surfaces 28. As will be described further below, the inboard surfaces 28 serve to align the SOE 20 to a solar cell assembly (not shown) and the recess 30 allows the SOE 20 to overlap the solar cell assembly. Also shown in FIG. 2 is an indentation 31 that serves as an output for excess index matching material disposed between the SOE 20 and a solar cell. Prior to placing the SOE 20 over a solar cell assembly and securing the SOE 20 to a backplate, an amount of index matching material is placed over the solar cell, which is part of the solar cell assembly. As the SOE 20 is pushed towards the solar cell assembly, the index matching material fills the space between the solar cell and the SOE 20 and any excess of index matching material can exit through the indentation 31.

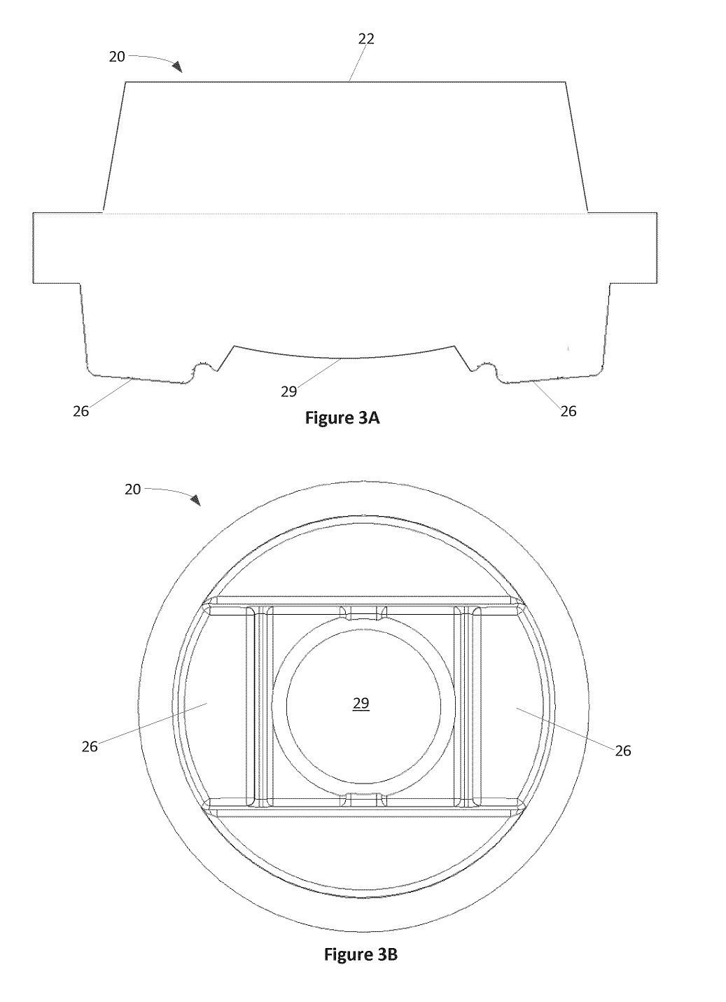

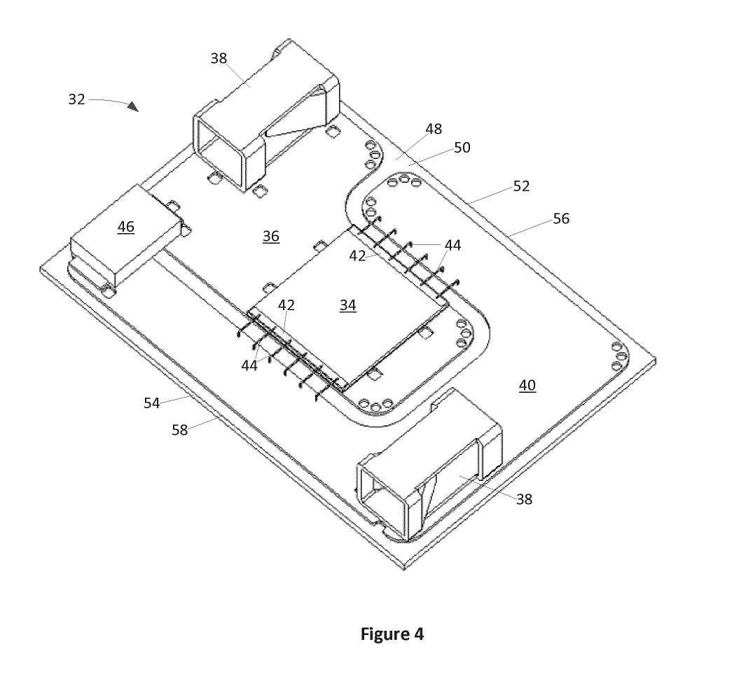

FIG. 3A shows a centre, cross-sectional view of the SOE 20 of FIG. 2.

As shown in FIG. 3A, the SOE 20 has an underside optical surface 29 out of which light transmits towards a solar cell (not shown). The underside optical surface 29 is shown as being convex; however, any other suitable surface geometry that cooperates with the light inputs surface 22 and with any other optical element in the light path in order to illuminate the solar cell is to be considered within the scope of the present disclosure.

FIG. 3B shows a bottom view the SOE 20 of FIG. 2. Shown in FIG. 3B are the underside optical surface 29 and the underside surfaces 26.

FIG. 4 shows an embodiment of a solar cell assembly (SCA) 32 in accordance with the present disclosure. The SCA 32 can also be referred to as a solar cell carrier assembly. The SCA 32 comprises a solar cell 34 electrically connected to a bottom contact 36, which is electrically connected to a wire connector 38. The solar cell 34 is also electrically connected to a top contact 40, which is electrically connected to another wire connector 38. The electrical connection between the solar cell 34 and the top contact 40 is effected through busbars 42 and wire bonds 44. The SCA also includes a bypass diode 48 electrically connected between the bottom contact 36 and the top contact 40.

The SCA 32 comprises a substrate 48. The substrate 48 can be made of any suitable material such as, for example, alumina, aluminum nitride, beryllium oxide, copper, fiberglass, etc. In some application, the substrate can have electrically insulating properties but be thermally conductive. In other application, where the heat to which the substrate is to be subjected is moderate, the substrate need only be electrically insulating. In other cases, where the backplate is electrically insulating, the substrate may be electrically conductive.

The bottom contact 36 and the top contact 40 are formed on a top surface 50 of the substrate 48, through any suitable process such as, for example, electroplating, direct bonding or direct plating. The bottom contact 36 and the top contact 48 can be made of gold-capped copper, aluminium or of any other suitable material. The bottom side (not shown) of the substrate 48 can also have a thermal and/or an electrical contact formed thereon.

The SCA 32 has side surfaces 52 and 54 that can serve as alignment features (alignment parts) for aligning the SOE 20 of FIGS. 1 and 2 with the SCA 32. The SCA 32 also defines edges 56 and 58 that can also serve as alignment features for aligning the SOE 20 with the SCA 32. In the present embodiment, the edges 56 and 58 are defined, respectively, by the side surfaces 52 and 58 and the top side 50 of the substrate 48.

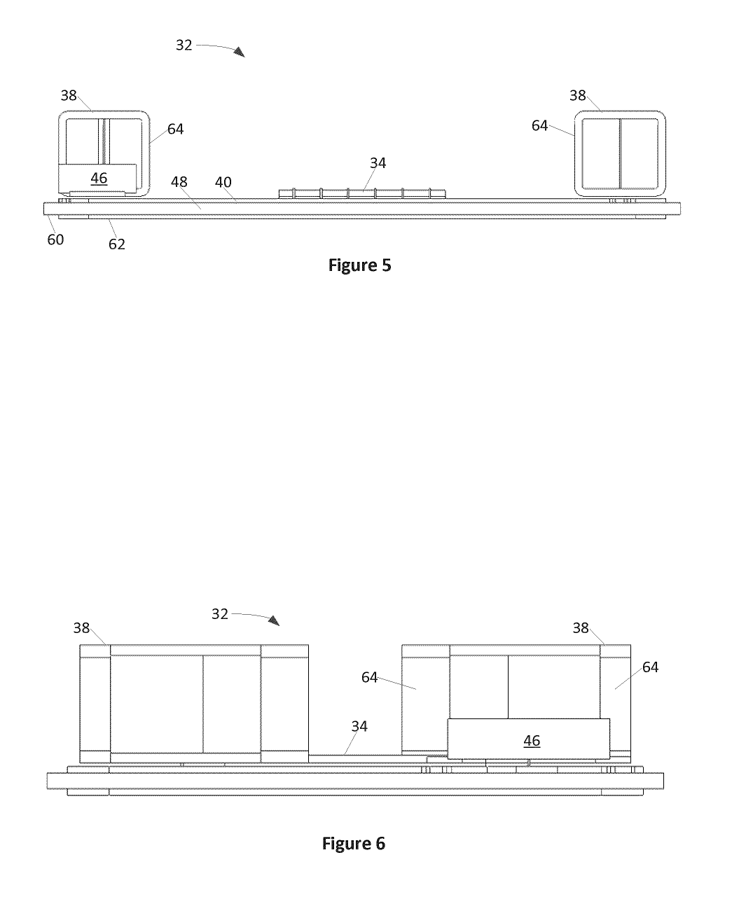

FIG. 5 shows a side view of the SCA 32. In addition to the solar cell 34, the top contact 40, the wire connectors 38, the bypass diode 46, and the substrate 48, the bottom side 60 of the substrate 48 is shown, as is a heat conducting layer 62 formed on the bottom surface 60. The heat conducting layer 62 can be made of the same material or materials as is the top contact 40. In some embodiments, no heat conducting layer is present.

In FIG. 5, the wire connectors 38 each define surfaces 64 that can also serve as alignment features for aligning the SOE 20 of FIGS. 1 and 2 with the SCA 32.

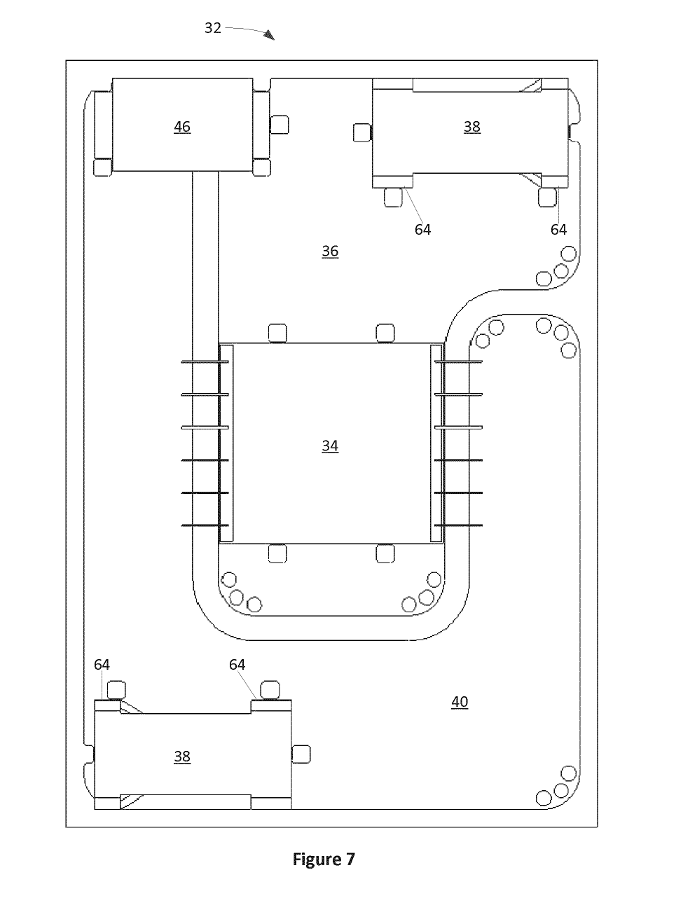

FIG. 6 shows another side view of the SCA 32 where the side surfaces 64 of the wire connector 38 associated with the top contact are shown. FIG. 7 shows a top view of the SCA 32 where the side surfaces 64 of the wire connectors 38 are shown.

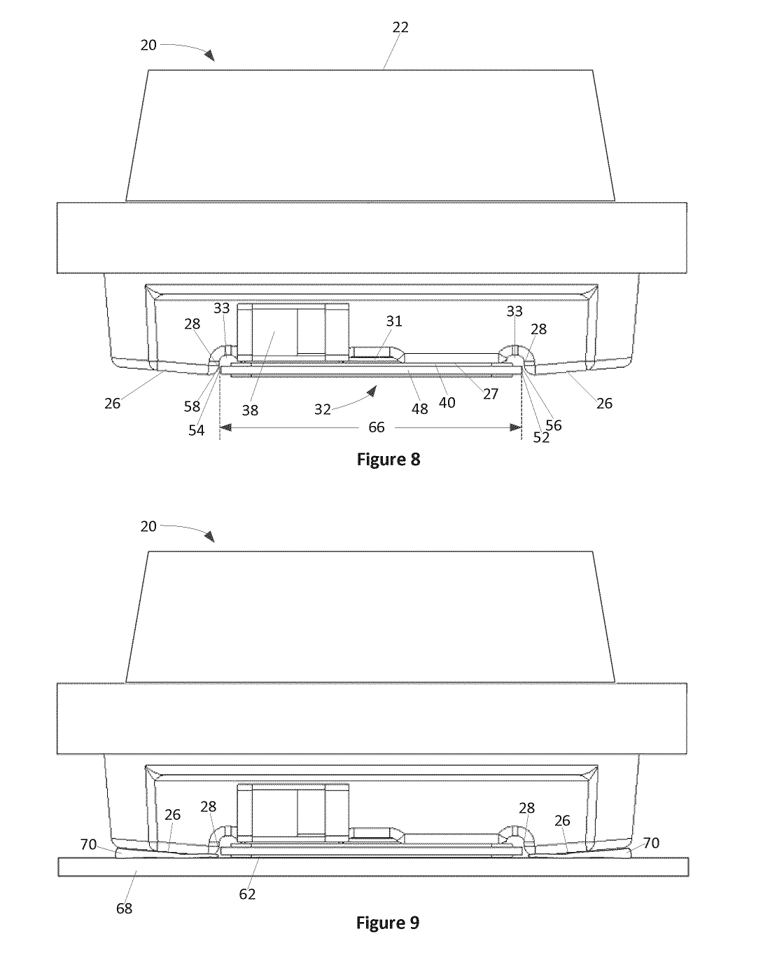

FIG. 8 shows a side view of the SOE 20 optically and physically coupled to the SCA 32. The side view of FIG. 8 shows the wire connector 38 associated with the top contact 40 shown in FIG. 7. The recess 30 shown at FIG. 2 allows the SOE 20 to overlap the SCA 32 and the level surfaces 27 shown at FIG. 1 allow the SOE 20 to rest on the SOE 20. One of the level surfaces 27 of FIG. 1 is shown in FIG. 8 as resting on the top contact 40 of the SCA 32.

FIG. 8 also shows how the SOE 20 is self-aligned with the SCA 32 by virtue of the side surfaces 52 and 54 and of the edges 56 and 58. The edges 56 and 58 of the SCA 32 are spaced-apart by a distance 66 that allows the SOE 20 to fit over the

SCA 32 such that both the inboard surfaces 28 of the SOE 20 overlap, at least partially, with the side surfaces 52 and 54, and with the edges 56 and 58. The undercuts 33 in the SOE 20 are to remove material of the SOE between the level surfaces 27 and their respective inboard surface 28 that may otherwise interfere with the SCA 32.

FIG. 9 shows the SCA 32 secured to a backplate 68. The underside surfaces 26 of the SOE 20 are secured to the backplate 68 by a bonding agent or adhesive 70. Also, the heat conducting layer 62 of the SCA 32 is secured to the backplate 68. The backplate can be made of aluminum, plastic, or any other suitable material. The underside surface 26 are bonded (secured) directly to the backplate. This is to be understood as meaning that any gap between the underside surfaces 26 and the backplate 68, can be filled, at least partially, with a bonding agent. The underside surfaces 26 need not physically touch the backplate 68 to be bonded directly to the backplate. The underside surfaces 26 being bonded directly to the backplate 68 also applies to embodiments where at least a portion of the undersides surfaces are in physical contact with the backplate 68.

The adhesive 70 used to bond the underside surfaces 26 to the backplate 68, or the SCA 32 to the backplate 68 can be, for example, a thermally conductive epoxy, a non-conductive epoxy, a thermally conductive silicone or a non-conductive silicone. Examples of thermally conductive epoxies include Masterbond SUP10AOHT™, SUP10ANHT™; MG Chemicals 8331 Silver Conductive Epoxy Adhesive™. Non-conductive epoxies may include Dow D.E.H. 20™. Examples of Thermally conductive silicone adhesives include Dow Corning@ SE 4450 and Nusil R-2930™. Examples of Non-conductive silicone adhesives can include Dow PV-804™. The adhesive used to bond the SOE 20 to the backplate 68 need not be the same as the adhesive used to bond the SCA 32 to the backplate 68. For example, a thermally conductive adhesive can be used to bond the SCA 32 to the backplate while a less specialized adhesive can be used to bond the SOE 32 to the backplate 68.

In some embodiments, prior to bonding the SOE 20 to the backplate 68, index matching material is placed over the solar cell 34 shown in FIG. 7. The amount of index matching material is selected to fill the space between the solar cell 34 and the SOE 20 when the SOE is secured to the backplate 68. Any excess index matching material can flow from between the solar cell 34 and the SOE 20 through the indentation 31 shown in FIG. 8.

In other embodiments, the SOE can be turned upside down and an index matching material can be placed on the underside optical surface of the SOE. The SCA can be mated to the SOE and, the SCA and the SOE can be clamped to each other. The clamped SOE and SCA can then be flipped over (SOE on top, SCA on bottom). This process allows bubbles in the silicone layer to migrate up and out of the optical path, along the convex, underside optical surface of the SOE. Subsequently, the SCA and the SOE can be bonded to the backplate.

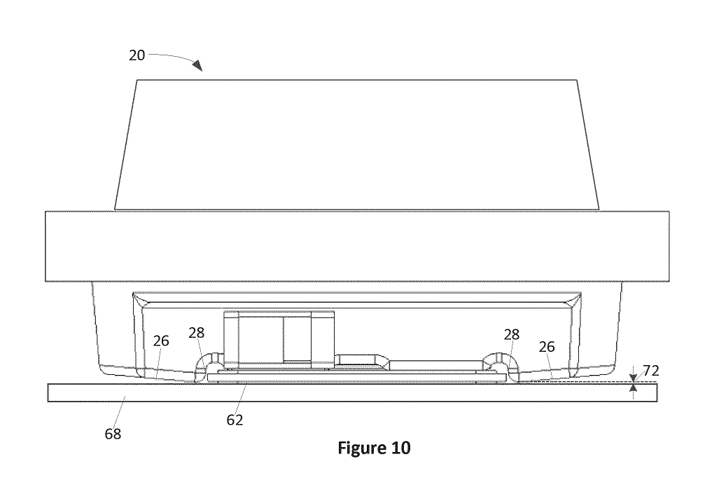

FIG. 10 shows a gap 72 between the SOE 20 and the backplate 68. This gap can measure 100 microns or any other suitable distance that allows the SOE 20 to rest on the SCA 32.

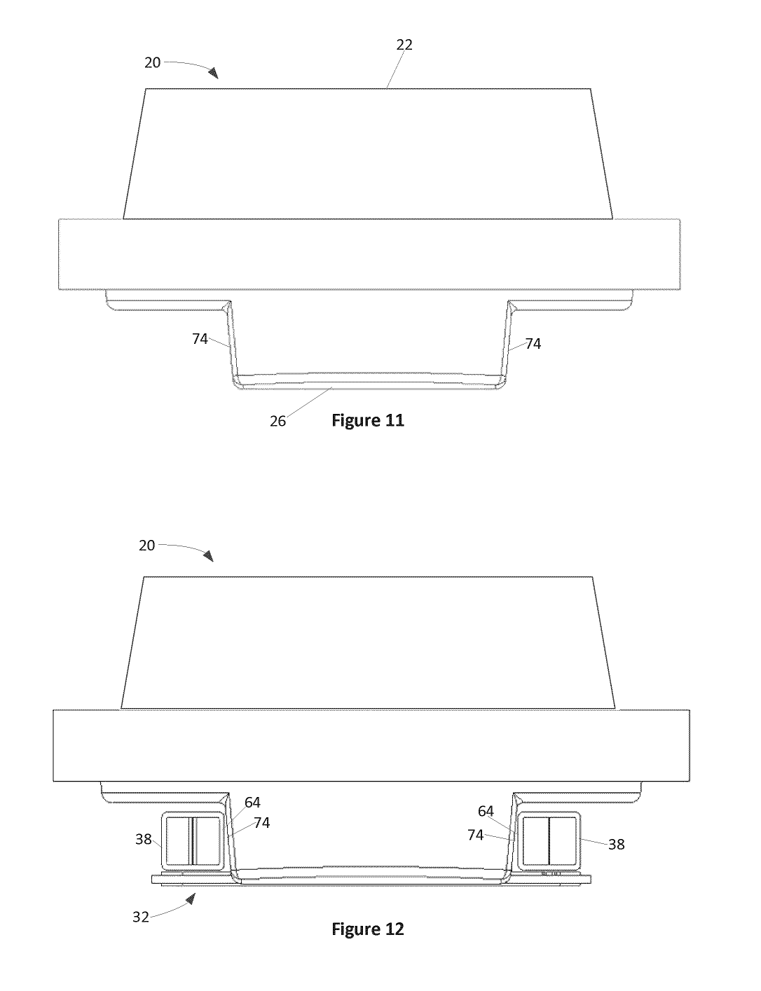

FIG. 11 shows a side view of an embodiment of the SOE 20 of the present disclosure. The side view shown at FIG. 11 is from a viewpoint located at 90° from the viewpoint of FIG. 1. Shown in FIG. 11 are the light input surface 22, one of the underside surfaces 26, and walls 74.

FIG. 12 shows the SOE 20 of FIG. 11 optically and physically coupled to the SCA 32. The walls 74 are dimensioned and oriented (slanted) to allow the SOE 20 be inserted and fitted between the surfaces 64 of the wire connectors 38. As such, the walls 74 of the SOE 20 and the surfaces 64 of the wire connectors 30 can cooperate with each other to self-align the SOE 20 to the SCA 32. In the present embodiment, the walls 74 are alignment features of the SOE 20 and the surfaces 64 are alignment features of the SCA 32.

As shown in FIG. 12, there is a gap between each wall 74 and its corresponding surface 64. These gaps are to allow the SOE 20 to rest on the SCA 32 and to minimize strain applied by the walls 74 to the wire connectors 39 and vice versa.

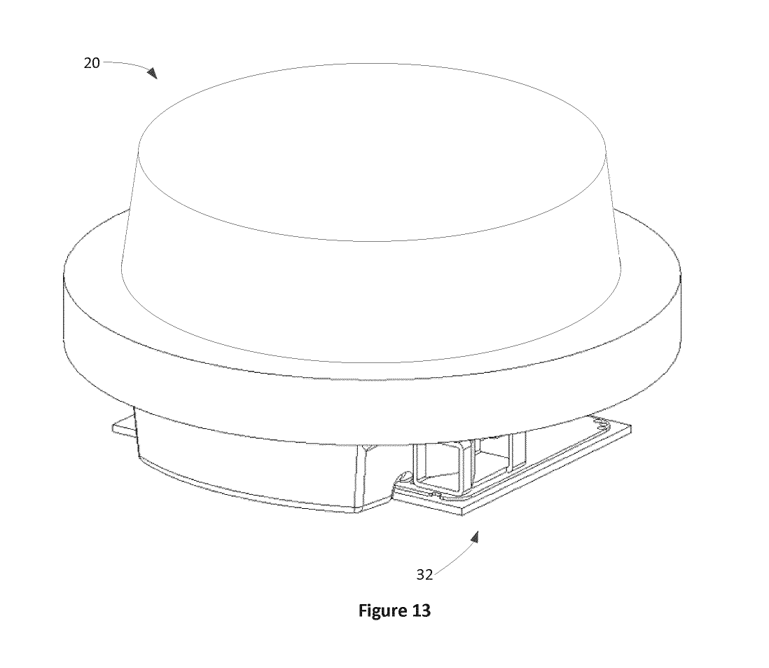

FIG. 13 shows a perspective view of the SOE 20 self-aligned to the SCA 32.

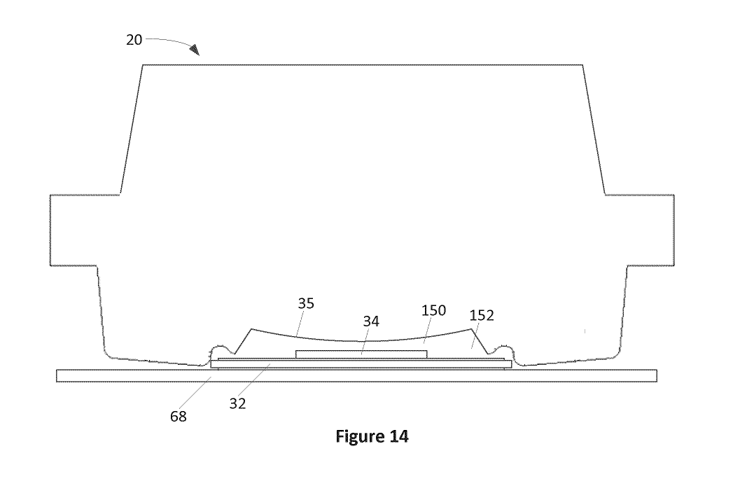

FIG. 14 shows the SOE 20 of FIG. 3A positioned (self-aligned) with the solar cell 34 of the SCA 32 of FIG. 4. Also shown in FIG. 14 is the backplate 68. The space (or volume) 150 between the SCA 32 and the SOE 20, and the space between the underside optical surface 35 and the solar cell 34, can be filled with an index matching material 152. The index matching material 152 can be, in some embodiments, an optical silicone such as, for example, Dow Sylgard 184™, a two part silicone elastomer, Dow Sylgard 3-6636™ Silicone dielectric gel, and Dow OE-6351, as well as Nu Sil, Shin Etsu and Henkel products. In other embodiments, non-curing silicone gels can be used. Examples of such non-curing silicone gels Dow OE-6250 and Dow OE-6450.

As shown in FIG. 14 the underside optical surface 35 is spaced-apart from the solar cell 34, which effectively avoids any shear stress between the underside optical surface 35 and the solar cell 34.

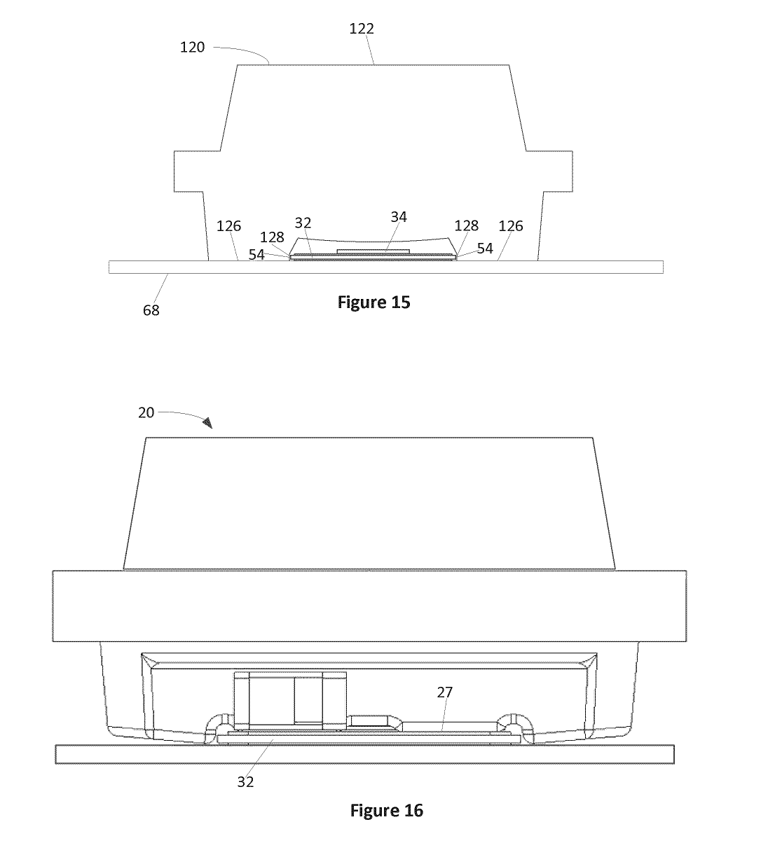

FIG. 15 shows a side cross-sectional view of another embodiment of a SOE 120 of the present disclosure bonded directly on a backplate 68 and overlapping the SCA 32. The SOE 100 has a light input surface 22 that receives light from a primary optical element (not shown). The SOE 20 concentrates the light onto the solar cell 34.

The SOE 120 has underside surfaces 126, which can also be referred to as non-optical surfaces or areas. Contrary to other embodiments, the embodiment of FIG. 15 provides no gap between the underside surfaces 126 and the backplate 68. Further, in the present embodiment, there is no requirement to have the SOE 120 rest on the SCA 32.

The SOE 120 has inboard surfaces 128 that cooperate with the sidewalls 54 of the SCA 32 to self-register (self-align) the SOE 120 to the SCA 32 and to the solar cell 34.

The SOE being self-registered to the SCA is to be understood as meaning that the SOE is optically aligned with the solar cell of the SCA simply by placing the SOE over the SCA such that one or more of the alignment features of the SOE cooperate with one or more of the alignment features of the SCA to align, optically, the SOE to the solar cell. For example, referring to FIG. 8, the SOE 20 can be self-registered to the SCA 32 simply by placing the SOE 20 over the SCA 32 such that the inboard surfaces 28 of the SOE 20 abut or overlap the side surfaces 52 and 54 of the SCA 32. The SOE 20 is also self-aligned to the SCA 32 by virtue of the walls 74 of the SOE 20 being placed adjacent the surfaces 64 of the wire connectors 38, as shown at FIG. 12. The manufacturing tolerances can be such that the SOE 20 will be optically coupled to the solar cell of the SCA 32 regardless of the inboard surfaces 28 abutting the side surfaces 52 and 54 or simply being adjacent the side surfaces 52 and 54. As an example, manufacturing tolerance with respect to length and widths can vary between 0.1 mm to 0.15 mm.

Within the context of the present disclosure, the expression “substantially abut” is to be understood as meaning, for example, that an alignment feature of the SOE is abutting (is in contact with) an alignment feature of the SCA or that the alignment feature of the SOE is not quite abutting the alignment feature of the SCA but the SOE is nevertheless optically aligned with the solar cell of the SCA. As an example, FIG. 8 shows the inboard surfaces 28 of the SOE 20 not quite in contact with the side surfaces 52 and 54 of the SCA 32; however, as the SOE 20 is aligned with the solar cell, it can be said that the inboard surfaces 28 substantially abut (or are substantially in contact with) respective side surfaces 52 and 54.

The examples presented above had, as alignment features, inboard surfaces of an SOE and side surfaces of an SCA. However, any other suitable alignment feature defined on the SOE and the SCA are to be considered within the scope of the present disclosure. For example one of the SCA and the SOE could have one or more boss that could fit into (cooperate with) corresponding one or more dimples (indentation) on the other of the SCA and the SOE to align the SOE to the SCA.

Examples presented above showed the SOE bonded directly to the backplate. This need not always be the case. In some other embodiments, the SOE can be self-aligned to the SCA as described elsewhere in the disclosure, and can be bonded to the SCA itself rather than to the backplate. FIG. 16 shows an example of the SOE 20 being self-aligned with the SCA 32 and being bonded, with an adhesive (not shown) to the SCA 32 along the level surface 27.

In the context of the present disclosure, the temperature cycling experienced by the backplate 68 is less than that experienced by the upper metalized surface of the SCA 32. By bonding the SOE 20 or 120 to the backplate 68 instead of the SCA, there is reduction in the thermally-induced stress SOE and the SCA. This enhances the lifetime of the bond, leading to greater system reliability.

The new optical train and SOE of the present disclosure provide a low-carbon efficient energy CPV system which is inexpensive to manufacture, to respond to the energy needs of expanding markets.

As an example, the new optical train can be part of a CPV module. multiple CPV modules can then be mounted on dual-axis trackers. The footprint of the modular system is 4.8 m×3.4 m, with an expected power output of over 5 kW. Each module is based on 40% high-efficiency, temperature-resistant, triple-junction solar cells. These cells split the solar spectrum into three specifically designed subcells that maximise the conversion of solar energy to electricity.

In some embodiments, the optical train can include a laminated PMMA Fresnel lens primary optic coupled to a four-lobe Kohler secondary optic that has been designed to minimize production costs while maximizing manufacturing tolerances and optical efficiency. The cell and SOE are mounted directly to the aluminium backplate isolating the requirements of mechanical and optical coupling and minimizing the potential for alignment error. The advanced optical train and mounting design allows for the use of a thermoset polymer casing which greatly reduces weight and cost.

The rear side of the backplate can be functionalized with a high emissivity thin-film coating that significantly lowers the cell operating temperature.

Advantageously, bonding the SOE 22 to the backplate or, in some embodiments, to the SCA, and not to the solar cell itself can minimize the opportunity for optical misalignment in the assembly process. Also advantageously, bonding the SOE to the backplate (or SCA) can allow for the bypass diode to be completely covered by non-optical parts of the SOE. That is, the bypass diode receives little light. This provides a shield against damage to the bypass diode caused by stray light during off axis events. This removes the need for an expensive/heavy shield layer of the bypass diode.

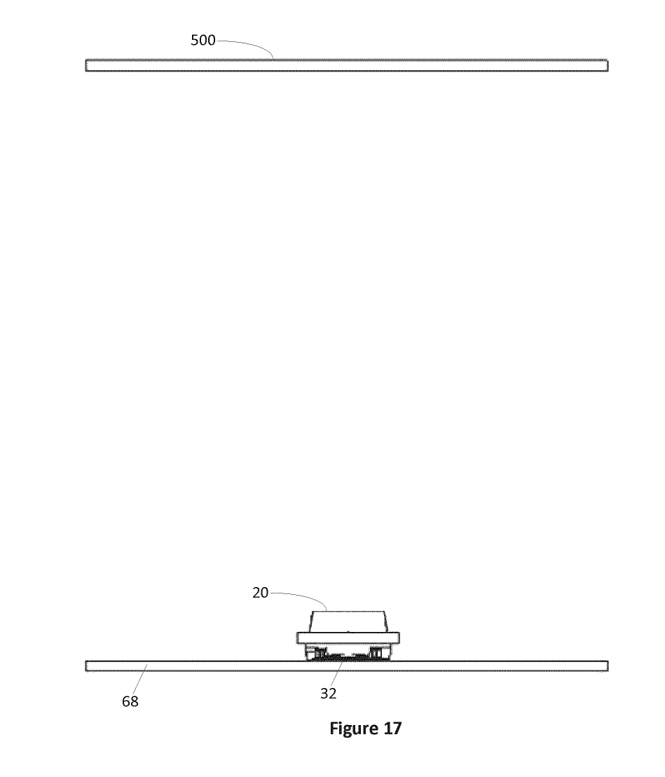

FIG. 17 shows a side, cross-sectional view of an embodiment of a CPV module of the present disclosure. Shown in FIG. 17 is a primary optical element 500, the SOE 20 that receives light from the primary optical element 500, the SCA 32, which has a solar cell that receives light from the SOE 20, and the backplate 68 onto which the SCA 32 and the SOE are bonded.

In general, and in the context of the present disclosure, two components are “electrically connected” when an electrical change caused by or affecting one (such as a change in voltage or current) can result in an electrical change in the other, or when an electrical signal sent by one can be received by the other. The two components need not be directly electrically connected (that is, there may be other elements interposed between them), and they may be, but need not be, proximate to one another. “Electrically connected” also includes the concept that components may be physically connected but the electrical circuit connections between them may be broken or completed by, for example, switching circuitry.

Further, in general, and in the context of the present disclosure, two components are optically coupled when a change in light at one component (such as a change in light intensity) can result in a change in light at the other, or when an optical signal stemming from one can be received by the other. Furthermore, two components are optically aligned when a majority of light stemming from one is received by the other or, when light intensity received at one component is within a pre-determined acceptable range or target range, or is equal to, or greater than, a target value. For example, given a standard light input, an SOE can be said to be optically aligned with a solar cell when the electrical signal generated at the solar cell by the light received at the solar cell from the SOE is equal to, or greater than, a target electrical signal value.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding.

The above-described embodiments are intended to be examples only. Alterations, modifications and variations can be effected to the particular embodiments by those of skill in the art without departing from the scope, which is defined solely by the claims appended hereto.

1. A concentrator photovoltaic (CPV) module comprising:
a backplate;
a solar cell assembly (SCA) secured to the backplate, the SCA having a solar cell mounted thereon, the SCA defining an SCA alignment feature; and
an optical element to guide light onto the solar cell, the optical element being bonded directly to the backplate, the optical element having an optical element alignment feature, the SCA alignment feature to cooperate with the optical element alignment feature to align the optical element with respect to the solar cell.

2. (canceled)

3. (canceled)

4. The CPV module of claim 1 wherein the SCA comprises a substrate that defines a side surface, the side surface defining the SCA alignment feature.

5. The CPV module of claim 4 wherein the optical element defines a recessed portion that overlies a portion of the SCA, the recessed portion having an inboard surface, the inboard surface defining the optical element alignment feature, the inboard surface to substantially abut the side surface of the substrate when the optical element is aligned to the solar cell.

6. The CPV module of claim 1 wherein the SCA comprises wire connectors, the wire connectors defining the SCA alignment feature.

7. The CPV module of claim 6 wherein the optical element defines walls, the walls defining the optical element alignment feature, each wall to substantially abut a respective wire connector when the optical element is aligned to the solar cell.

8. The CPV module of claim 1 wherein the optical element defines a level surface that abuts against the SCA when the SCA is aligned to the solar cell.

9. The CPV module of claim 1 wherein the optical element has underside surfaces that are secured directly to the backplate.

10. The CPV module of claim 9 further comprising an adhesive to secure the underside surface to the backplate, the undersides surfaces being slanted, the slant of each underside surface to cause at least a portion of the adhesive to be pushed away from the SCA when the optical element is being mated to the SCA and moved towards the backplate.

11. The CPV module of claim 1 wherein the optical element has an underside optical surface spaced-apart from the solar cell when the optical element is mounted on the SCA and the optical element is aligned with the solar cell.

12. The CPV module of claim 11 wherein a volume between the underside optical surface of the optical element and the solar cell is occupied by an index matching material.

13. An optical element to guide light onto a solar cell mounted on a solar cell assembly (SCA), the SCA being mounted on a backplate, the optical element comprising:
an optical element alignment part to cooperate with an SCA alignment part to align the optical element to the solar cell when the optical element is mated to the SCA;
an underside portion with underside surfaces, the underside surfaces for being bonded directly to the backplate.

14. The optical element of claim 13 wherein the optical element defines a recessed portion that overlies a portion of the SCA, the recessed portion having an inboard surface, the inboard surface defining the optical element alignment part, the substrate having a side surface, the inboard surface to substantially abut the side surface of the substrate when the optical element is aligned to the solar cell.

15. The optical element of claim 13 further comprising a level surface that abuts against the SCA when the optical element is aligned to the solar cell.

16. (canceled)

17. The optical element of claim 13 wherein the undersides surfaces are slanted, the underside surfaces to be bonded to the backplate with an adhesive, the slant of each underside surface to cause at least a portion of the adhesive to be pushed away from the SCA when the optical element is being mated to the SCA and moved towards the backplate.

18. The optical element of claim 13 has an underside optical surface spaced-apart from the solar cell when the optical element is mounted on the SCA and the optical element is aligned with the solar cell.

19. The optical element of claim 14 further comprising a level surface that abuts against the SCA when the optical element is aligned to the solar cell.
